(19) United States
(12) Patent Application Publication
(10) Pub. No.: US 2014/0332604 A1
(43) Pub. Date: Nov. 13, 2014

(54) Device for Fastening a Hollow Part

(71) Applicant: HERAKLES, Le Haillan (FR)

(72) Inventors: Marc Andlauer, Merignac (FR); Pascal Ducrot, Gradignan (FR)

(73) Assignee: HERAKLES, Le Haillan (FR)

(21) Appl. No.: 14/353,840

(22) PCT Filed: Sep. 26, 2012
(86) PCT No.: PCT/FR2012/052161

§ 371 Date: Apr. 24, 2014

(30) Foreign Application Priority Data
Oct. 24, 2011 (FR) 1103242

(51) Int. Cl. F02K 1/04; F02K 1/82; F02K 1/80

(52) U.S. Cl. CPC F02K 1/04; F02K 1/80; F02K 1/822
USPC 239/265.11; 403/167; 60/766

(57) ABSTRACT

A fastener device for fastening a hollow part is made up of two mutually facing walls to at least one structural part. The device comprises a one-piece body of metal material presenting two main faces extending longitudinally between first and second ends of the body. Each main face includes a bearing portion in the vicinity of the first end of the body. The bearing portion is for being pressed against an inside surface of a respective one of the two walls of the hollow part, with each bearing portion including a fastener orifice for receiving a fastener member. The bearing portions are separated from each other by a slot extending from the first end of the body and over a determined depth within the body.

### BACKGROUND OF THE INVENTION

The present invention relates to fastening and integrating hollow parts, particularly but not exclusively parts made of composite material, within assemblies comprising one or more parts to which the hollow part is to be fastened, such as aeroengines, for example.

FIG. 1 shows a nozzle 100 of a helicopter engine having an exhaust cone 110 on which a converging nozzle 120 is mounted coaxially by means of three arms 130, each formed by a hollow body 131, which arms are distributed uniformly between the cone 110 and the nozzle 120. The exhaust cone 110, the nozzle 120, and the arm 130 are all made of composite material, e.g. ceramic matrix composite (CMC) material. Each arm 130 is fastened firstly at one of its ends to the outer wall of the exhaust cone 110 via two angle tabs 132 formed integrally with the body 131 of the arm, and secondly, at its other end, to the inner wall of the nozzle 120 via an angle tab 133 that is likewise integrally formed with the body 131 of the arm. The pairs of angle tabs 132 and the angle tabs 133 are held respectively on the cone 110 and on the nozzle 120 by bolts 140 and 150.

Nevertheless, incorporating composite material arms in that way presents drawbacks. The connections via angle tabs significantly increase the overall size of each arm, and it is difficult to determine the dimensions of the angle tabs relative to the radii of curvature of the cone and of the nozzle, each of which needs to be taken into consideration for each arm. Furthermore, the angle tabs and the heads of the bolts project into the flow passage, thereby causing the connection devices to interfere with aerodynamic flow. Finally, although the angle tabs are good at taking up structural forces, they can accommodate little tolerance in terms of shape, which makes assembly difficult.

Among the devices that are used for fastening a composite material part on one or more metal parts while accommodating differential expansions between those materials, it is known to make use of elastically flexible fastener tabs generally made of refractory metal material, such as those described in Document US 2008/115484. Nevertheless, although those flexible fastener tabs are well adapted to fastening together parts of large dimensions, they are more difficult to use for fastening hollow parts of smaller dimensions.

There exists a need for means for fastening hollow parts on one or more structural parts, which means serve both to take up structural forces well and also to provide good shape tolerance, while presenting very little aerodynamic interference.

### OBJECT AND SUMMARY OF THE INVENTION

To this end, the present invention proposes an assembly comprising at least one hollow part fastened on at least one structural part, the assembly being characterized in that it further comprises at least one fastener device placed inside each hollow part, said fastener device comprising a one-piece body made of metal material presenting two main faces extending longitudinally between first and second ends of said body, each main face including a bearing portion in the vicinity of the first end of said body, each bearing portion including a fastener orifice for receiving a fastener member, the bearing portions being separated from each other by a slot extending from the first end of said body and over a determined depth within said body, the second end including at least one fastener orifice for receiving a fastener member. The assembly of the invention is also characterized in that the two bearing portions of each fastener device are pressed against the inside surfaces of respective ones of the two walls of said hollow part by fastener members arranged in the fastener orifices of said bearing portions, the second end of the fastener device being fastened on the structural part by a fastener member arranged in the fastener orifice present in said second end.

The fastener device of the invention presents a compact structure enabling it to be inserted inside the hollow part, and apart from the ends of the fastener members (heads of bolts, for example), the fastener device as a whole has no impact on the aerodynamic performance of the assembly.

In addition, because of its partially slotted structure, any expansion of the fastener device between the two walls of the hollow part to which it is fastened can be compensated while still taking up forces effectively in other directions. The flexibility imparted by the slot also makes it possible for the fastener device to be fabricated with relaxed manufacturing tolerances.

In a first aspect of the assembly of the invention, the fastener orifices of the bearing portions of the fastener device are offset transversely relative to each other so as to make it possible to take up any tilting torque that might be applied to the hollow part.

In a second aspect of the assembly of the invention, each bearing portion forms extra thickness on the main face on which it is formed, thus making it possible to be unaffected by any shape defects of the hollow part by setting back the faces of a device other than in their bearing portions. Furthermore, the extra thickness in each bearing portion forms a reserve of material that can be machined, should that be necessary, in order to achieve accurate fitting relative to the inside surfaces of the walls of the hollow body (retouching the contacting surfaces).

In a third aspect of the assembly of the invention, the fastener device further includes a bore of determined diameter extending transversely in the one-piece body of the fastener device and into which the slot leads. This bore makes it possible to increase and to adjust the flexibility in movement between the two bearing portions in the event of differential expansion and/or when the device is being mounted.

According to a particular characteristic, the fastener device is made of a refractory metal material selected from at least: Inconel®, Hastelloy®, or Waspalloy®.

According to another particular characteristic, the hollow part is made of composite material.

In an embodiment of the invention, the assembly comprises two structural parts corresponding respectively to an exhaust cone and to a nozzle of an aeroengine, said nozzle being held coaxially on said cone by a plurality of arms, each formed by a hollow part of composite material, each arm being connected to said cone by a first fastener device and to the nozzle by a second fastener device. Specifically, the exhaust cone and the nozzle may be made of composite material.

In another embodiment of the invention, the fastener assembly comprises a structural part of metal material corresponding to a cylindrical reheat channel of a turbojet having an afterburner, said reheat channel having a plurality of flame-holder arms, each formed by a hollow part made of composite material arranged radially on the inside surface of the cylindrical reheat channel, each flame-holder arm being connected to the cylindrical reheat channel by a respective fastener device.

### BRIEF DESCRIPTION OF THE DRAWINGS

Other characteristics and advantages of the invention appear from the following description of particular embodiments of the invention given as non-limiting examples and with reference to the accompanying drawings, in which:

FIG. 1 is a perspective view of a prior art helicopter engine exhaust assembly;

FIG. 2 is a perspective view of a helicopter engine exhaust assembly in accordance with an embodiment of the invention;

FIGS. 3A and 3B are perspective views of a fastener device in accordance with an embodiment of the invention;

FIG. 4 is a section view of an arm of the assembly shown in FIG. 2;

FIGS. 5A and 5B are section views of the arm shown in FIG. 4; and

FIG. 6 is a section view of a reheat channel of a turbojet with an afterburner including a flame-holder arm fastened by a fastener device in accordance with the invention.

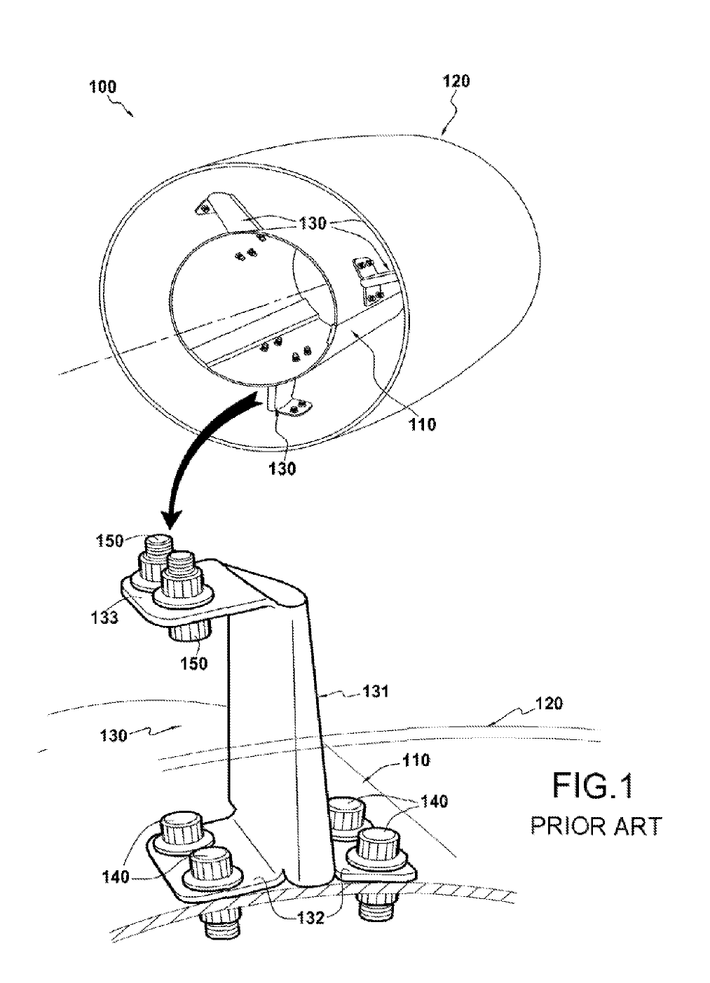

### DETAILED DESCRIPTION OF AN EMBODIMENT

The present invention proposes an assembly comprising at least one fastener device, one or more hollow parts, and one or more structural parts, the hollow parts and the structural parts being made of metal material or of composite material.

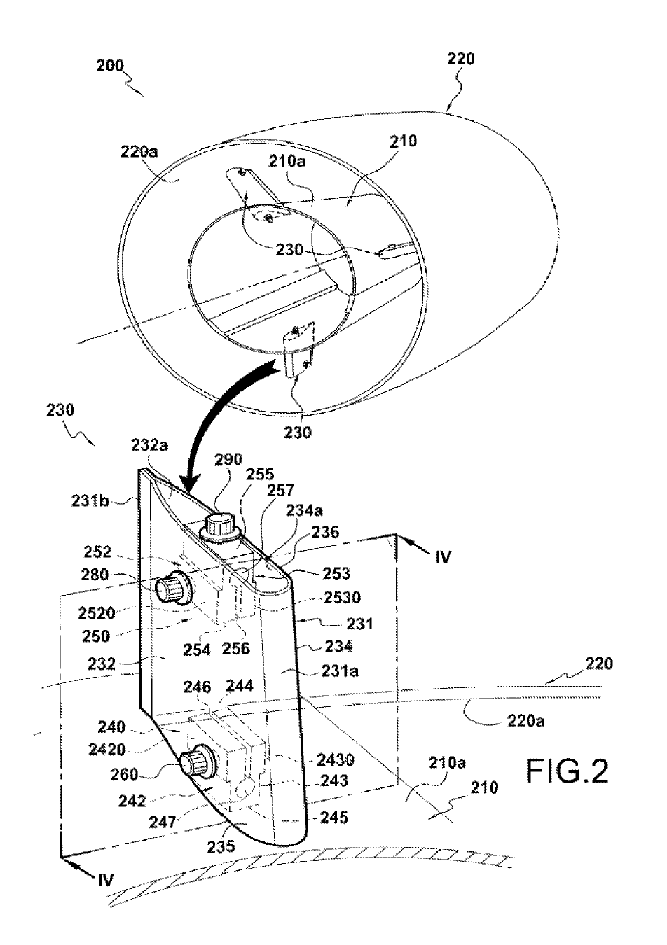

FIG. 2 shows a helicopter engine exhaust assembly 200 comprising an exhaust cone 210 and a converging nozzle 220 that is held coaxially on the exhaust cone 210 by means of three arms 230. The exhaust cone 210 and the nozzle 220 are made of composite material. Nevertheless, one of those two parts or indeed both of them could be made of a metal material. The arms 230 are made of thermostructural composite material, specifically CMC material.

In well-known manner, the CMC material parts are constituted by fiber reinforcement made of refractory fibers (carbon fibers or ceramic fibers) and densified by a ceramic matrix, in particular made of carbide, nitride, refractory oxide, . . . . Typical examples of CMC materials are C—SiC materials (carbon fiber reinforcement with silicon carbide matrix), SiC—SiC materials, and C—C/SiC materials (matrix comprising both carbon and silicon carbide). The fabrication of CMC composite parts is well known. The fiber reinforcement may be densified by a liquid technique (impregnating with a ceramic matrix precursor resin and transforming the resin into a ceramic by curing and pyrolysis, which process may be repeated) or by a gaseous technique (chemical vapor infiltration (CVI)).

Each arm 230 is in the form of a hollow body 231 of streamlined profile having two facing walls 232 and 234 that extend between a leading edge 231a and a trailing edge 231b. The inner end 235 of each arm is fastened on the outer wall 210a of the exhaust cone 210 by means of a fastener device 240 in accordance with the invention, which device is arranged inside the hollow body 231. The outer end 236 of each arm is fastened to the inner wall 220a of the nozzle 220 by means of a fastener device 250 in accordance with the invention, which device is arranged inside the hollow body 231.

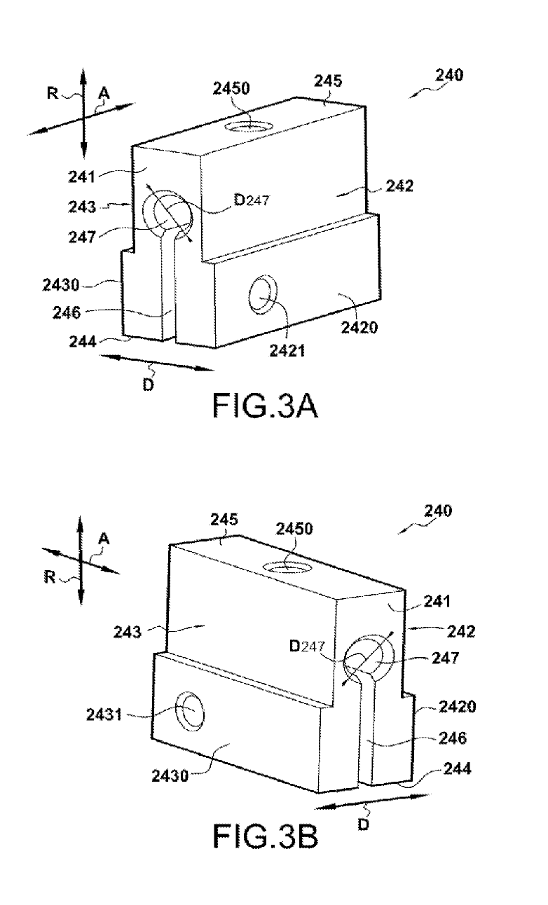

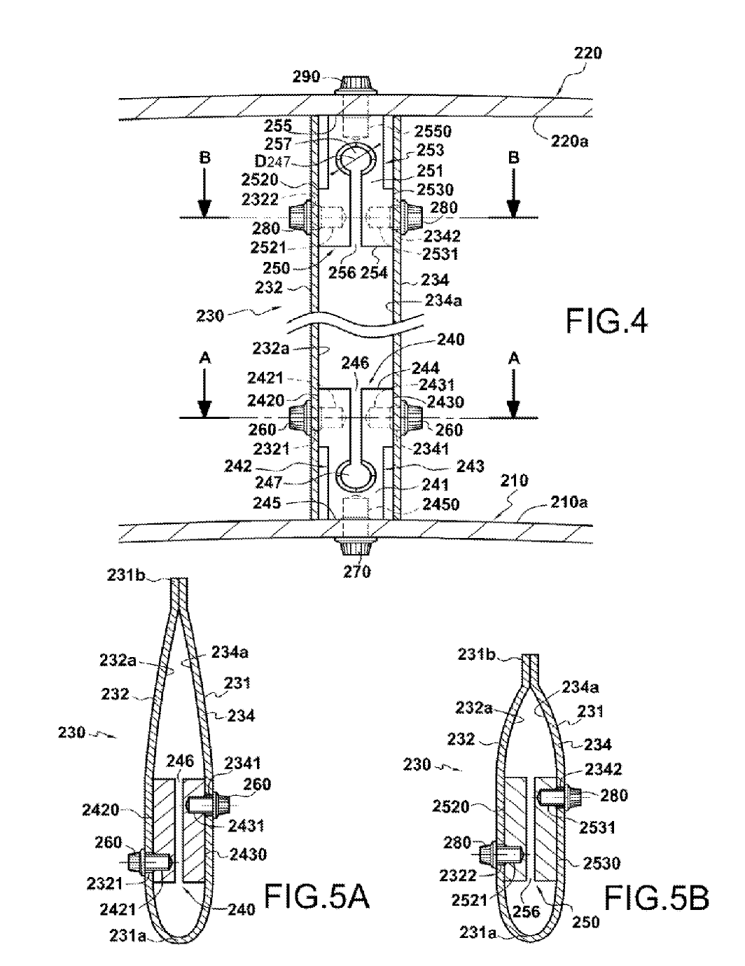

More precisely, in the presently-described embodiment shown in FIGS. 3A and 3B, the fastener device 240 comprises a one-piece body 241 made of metal material and, in this example, substantially in the form of a rectangular parallelepiped with two main faces 242 and 243 that extend longitudinally between a first end 244 and a second end 245 of the body 241. Each main face 242, 243 includes a respective bearing portion 2420, 2430 in the vicinity of the first end 244 of the body for the purpose of being pressed against the inside surface 232a of the wall 232 or respectively against the inside surface 234a of the wall 244 of the hollow body 231 made of composite material. Each bearing portion 2420, 2430 has a respective fastener orifice 2421, 2431 for receiving a fastener member. In the presently-described embodiment, each of the fastener orifices 2421, 2431 has tapping enabling the bearing portions 2420, 2430 to be secured to the walls 232, 234 respectively of the hollow body 231 of the arm 230 for tightening bolts 260 inserted into the fastener orifices 2421, 2431 via through orifices 2321, 2341 formed respectively in the walls 232 and 234 (FIGS. 4 and 5A).

The fastener device 240 also has a slot 246 extending from the end 244 of the body 241 over a determined depth into the body so as to separate the bearing portions 2420 and 2430. The slot 246 imparts flexibility to the bearing portions 2420, 2430 enabling them to move relative to each other in a direction D serving to compensate for any expansion of each fastener device relative to the arm 230 to which it is fastened. The flexibility imparted by the slot also serves to accommodate a certain amount of dispersion during fabrication, thereby increasing the shape tolerance of the fastener device. Nevertheless, the presence of the slot does not prevent good transmission of forces in the directions R and A corresponding respectively to radial forces and to axial forces in the exhaust assembly 200.

In the presently-described embodiment, the body 241 of the fastener device also has a cylindrical bore 247 into which the slot 246 leads. By having a greater amount of material removed therefrom, the bore 247 serves to increase flexibility in the direction D between the bearing portions 2420 and 2430 as imparted by the slot 246. The diameter D₂₄₇ of the bore 247 is determined as a function of the degree of flexibility that it is desired to have between the bearing portions. It is thus possible to adjust the capacity for deformation of each fastener device of the invention, in particular as a function of the amplitude of the expansion of the fastener device.

The end 245 forms a portion for fastening the device 240 on the outer wall 210a of the exhaust cone 210. The end 245 has a fastener orifice 2450 for receiving a fastener member. In the presently-described embodiment, the fastener orifice 2450 includes tapping serving to secure the end 245 of each fastener device 240 to the outer wall 210a of the cone 210 by tightening a bolt 270 inserted into the fastener orifice 2450 via a through orifice 2101 formed in the cone 210 (FIG. 4).

Each bearing portion 2420 and 2430 preferably has respective extra thickness on the main face 242 or the main face 243, thus making it possible to ignore possible defective shapes of the hollow bodies 231 by being set back from the faces 242 and 243, except where bearing against them. Furthermore, the extra thickness in each bearing portion 2420, 2430 forms extra material that can be machined in order to be made to fit accurately against the inside surfaces of the walls of the hollow body (retouching the contacting surfaces).

As shown in FIG. 5A, the fastener orifices 2421 and 2431 are offset transversely (along the axis of the cone 210 and of the nozzle 220) relative to each other so as to take up any tilting torque that might be applied to the arms 230.

Likewise, the fastener device 250 serving to connect the outer end 236 of each arm 230 to the inner wall 220a of the nozzle 220 is constituted by a one-piece body 251 of metal material having two main faces 252 and 253 extending longitudinally between a first end 254 and a second end 255 of the body.

Each main face 252, 253 includes a respective bearing portion 2520, 2530 in the vicinity of the first end 254 of the body, which bearing portion forms extra thickness on the corresponding main face that is to be pressed against the inside surface 232a of the wall 232 or the inside surface 234a of the wall 234 of the hollow body 231 made of composite material.

Each bearing portion 2520, 2530 has a respective fastener orifice 2521, 2531 for receiving a fastener member and, in the presently-described embodiment, it includes tapping for enabling the bearing portions 2520 and 2530 to be secured respectively to the walls 232 and 234 of the hollow body 231 of the arm 230 by tightening bolts 280 inserted into the fastener orifices 2521 and 2531 via through orifices 2322 and 2342 formed respectively in the walls 232 and 234 (FIGS. 4 and 5B). The fastener orifices 2521 and 2531 are offset transversely in order to take up tilting torque.

Like the fastener device 240, the fastener device 250 also has a slot 256 that extends from the end 254 of the body 251 to a determined depth within the body so as to separate the bearing portions 2520 and 2530. The slot 256 serves to impart flexibility to the bearing portions 2520 and 2530, enabling them to move relative to each other in a direction D, thus making it possible to accommodate any expansion of the fastener device relative to the arms 230 of composite material. The slots 256 also serve to increase the shape tolerance of the device, which can thus accommodate a certain amount of dispersion during fabrication. The body 251 of the fastener device also has a cylindrical bore 257 into which the slot 256 leads, thereby making it possible to increase flexibility in the direction D. The diameter D₂₅₇ of the bore 257 is adjusted depending on the desired degree of flexibility.

The end 255 forms a portion for fastening the device 250 to the outer wall 220a of the nozzle 220 and it includes a fastener orifice 2550 for receiving a fastener member, specifically a bolt 290 inserted into the fastener orifice 2550 via a through orifice 2201 formed in the nozzle 220 (FIG. 4).

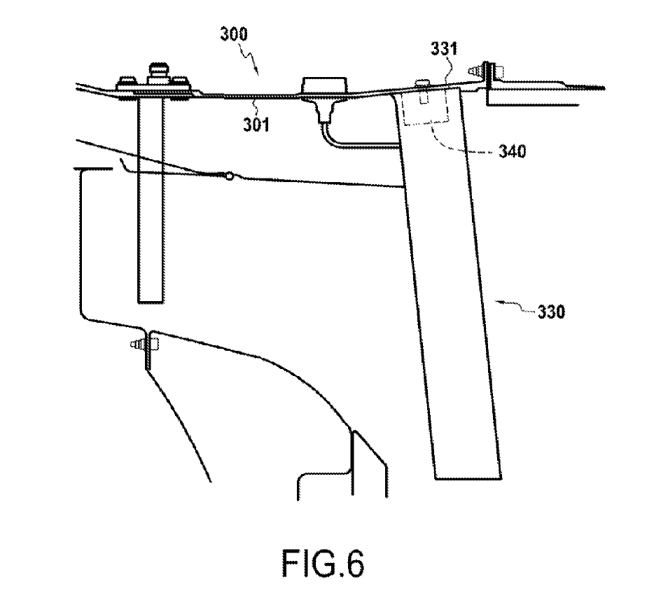

In the above-described example, the hollow parts are fastened at both ends, each with the help of a respective fastener device of the invention. Nevertheless, the invention also applies to fastening hollow parts made of composite material via only one of their ends. FIG. 6 shows a portion of a cylindrical reheat channel 300 of a turbojet with an afterburner. In well-known manner, the reheat channel 300 is made of metal material and includes on its inner periphery 301 a plurality of flame-holder arms 330 (only one arm being shown in FIG. 6), which arms are distributed uniformly around the inner periphery 301 of the channel. Each arm 330 extends radially in the channel between a first end 331 connected to the inner surface 301 of the channel and a second end 332 that is free. In accordance with the invention, each flame-holder arm 330 is made of composite material, e.g. of CMC material, and it is fastened to the inner surface 301 of the cylindrical reheat channel 300 by means of a fastener device 340 similar to the above-described fastener devices 240 and 250.

In the present invention, the fastener devices are made of a refractory metal material in particular such as: Inconel®, Hastelloy®, or Waspalloy®.

The fastener devices of the present invention may be fastened to the hollow part and/or to other structural parts by fastener members other than bolts, such as for example by means of rivets.

1-9. (canceled)

10. An assembly including at least one hollow part fastened on at least one structural part, wherein said assembly comprising at least one fastener device placed inside each hollow part, said fastener device comprising a one-piece body made of metal material presenting two main faces extending longitudinally between first and second ends of said body, each main face including a bearing portion in the vicinity of the first end of said body, each bearing portion including a fastener orifice for receiving a fastener member, the bearing portions being separated from each other by a slot extending from the first end of said body and over a determined depth within said body, the second end including at least one fastener orifice for receiving a fastener member, and wherein the two bearing portions of each fastener device are pressed against the inside surfaces of respective ones of the two walls of said hollow part by fastener members arranged in the fastener orifices of said bearing portions, the second end of the fastener device being fastened on the structural part by a fastener member arranged in the fastener orifice present in said second end.

11. An assembly according to claim 10, wherein the fastener orifices of the bearing portions are offset transversely relative to each other.

12. An assembly according to claim 10, wherein each bearing portion forms extra thickness on the main face on which it is formed.

13. An assembly according to claim 10, wherein further including a bore of determined diameter extending transversely in the one-piece body of said fastener device and into which the slot leads.

14. An assembly according to claim 10, wherein it is made of a refractory metal material selected from at least: Inconel®, Hastelloy®, or Waspalloy®.

15. An assembly according to claim 10, wherein the hollow part is made of composite material.

16. An assembly according to claim 10, wherein comprising two structural parts corresponding respectively to an exhaust cone and to a converging nozzle of an aeroengine, said nozzle being held coaxially on said cone by a plurality of arms, each formed by a hollow part of composite material, each arm being connected to said cone by a first fastener device and to said nozzle by a second fastener device.

17. An assembly according to claim 16, wherein the structural parts corresponding respectively to the exhaust cone and to the converging nozzle are made of composite material.

18. An assembly according to claim 10, wherein including a structural part of metal material corresponding to a cylindrical reheat channel of a turbojet having an afterburner, said reheat channel having a plurality of flame-holder arms, each formed by a hollow part made of composite material arranged radially on the inside surface of the cylindrical reheat channel, each flame-holder arm being connected to the cylindrical reheat channel by a respective fastener device.
